(19) United States
(12) Patent Application Publication
(10) Pub. No.: US 2025/0301072 A1
(43) Pub. Date: Sep. 25, 2025

(54) INFORMATION PROCESSING SYSTEM, NON-TRANSITORY COMPUTER-READABLE STORAGE MEDIUM, AND CONTROL METHOD

(71) Applicant: FUJIFILM Business Innovation Corp., Tokyo (JP)

(72) Inventor: Katsutoshi SAKAGUCHI, Kanagawa (JP)

(73) Assignee: FUJIFILM Business Innovation Corp., Tokyo (JP)

(21) Appl. No.: 18/778,100

(22) Filed: Jul. 19, 2024

(30) Foreign Application Priority Data
Mar. 25, 2024 (JP) 2024-048710

(51) Int. Cl. H04N 1/00; G06F 3/14

(52) U.S. Cl. CPC H04N 1/00129; G06F 3/1454; H04N 1/00037

(57) ABSTRACT

An information processing system includes a processor, wherein the processor: acquires information on a distance and an angle of a user terminal with respect to a specific position; and displays, on a display unit of the user terminal, a screen corresponding to a specific area when detecting that the user terminal is present within a range set with reference to the specific area among a plurality of areas of the information processing system using the information on the distance and the angle of the user terminal.

### CROSS-REFERENCE TO RELATED APPLICATIONS

This application is based on and claims priority under 35 USC 119 from Japanese Patent Application No. 2024-048710 filed Mar. 25, 2024.

### BACKGROUND

### (i) Technical Field

The present disclosure relates to an information processing system, a non-transitory computer-readable storage medium, and a control method.

### (ii) Related Art

JP2018-158496A describes an image forming apparatus in which, when a trouble such as a paper jam has occurred at a plurality of locations at the same time, if a display order of guidance images indicating a trouble-shooting method for each location is set in advance, the display order of the guidance images is switched in accordance with detection of approach of a person other than an operator to the image forming apparatus, thereby efficiently performing trouble-shooting processing.

JP2015-162041A describes a portable terminal device in which, when some abnormality has occurred in an image forming apparatus, an abnormal state of the image forming apparatus is displayed on a display panel with display contents corresponding to a relative distance between the portable terminal device that displays a remote panel and the image forming apparatus.

### SUMMARY

Aspects of non-limiting embodiments of the present disclosure relate to an information processing system, a non-transitory computer-readable storage medium, and a control method capable of displaying, when a user has approached a specific area among a plurality of areas of the system, a screen corresponding to the area on a display unit of a user terminal.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an information processing system comprising a processor, wherein the processor: acquires information on a distance and an angle of a user terminal with respect to a specific position; and displays, on a display unit of the user terminal, a screen corresponding to a specific area when detecting that the user terminal is present within a range set with reference to the specific area among a plurality of areas of the information processing system using the information on the distance and the angle of the user terminal.

### BRIEF DESCRIPTION OF THE DRAWINGS

Exemplary embodiments of the present invention will be described in detail based on the following figures, wherein:

FIG. 1 is a diagram illustrating a system configuration of an image forming apparatus according to an exemplary embodiment of the present disclosure;

FIG. 2 is a block diagram illustrating a hardware configuration of the image forming apparatus;

FIG. 3 is a diagram for describing a principle of acquiring a reception angle of a radio wave from a user terminal;

FIG. 4 is a block diagram illustrating a functional configuration of the image forming apparatus;

FIG. 5 is a diagram illustrating a display example of a screen when an error has occurred in the image forming apparatus;

FIG. 6 is a diagram for describing a case where only a reception distance of a radio wave from the user terminal is acquired;

FIG. 7 is a diagram illustrating an example of a device management table; and

FIG. 8 is a flowchart for describing a flow of error display processing at the time of mirroring in the image forming apparatus.

### DETAILED DESCRIPTION

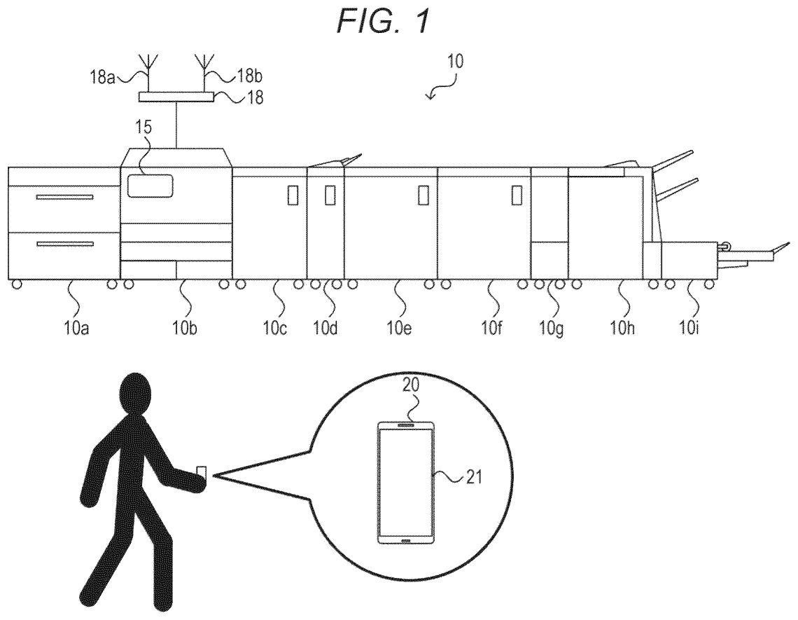

Hereinafter, form examples for carrying out the technology of the present disclosure will be described in detail with reference to the drawings. FIG. 1 is a diagram illustrating a system configuration of an image forming apparatus 10 according to an exemplary embodiment of the present disclosure.

The image forming apparatus 10 is a so-called multifunction machine having a plurality of functions such as a printing function, a scanning function, a copying function, and a facsimile function. The image forming apparatus 10 is an example of an information processing system in the technology of the present disclosure.

As illustrated in FIG. 1, the image forming apparatus 10 includes a paper feed tray 10a, a main body 10b, an interface decurler 10c, an interposer 10d, a stacker 10e, a vertical trimmer creaser 10f, a paper folding unit 10g, a saddle stitching finisher 10h, and a trimmer folder 10i. The paper feed tray 10a is joined to the upstream side of the main body 10b.

The interface decurler 10c, the interposer 10d, the stacker 10e, the vertical trimmer creaser 10f, the paper folding unit 10g, the saddle stitching finisher 10h, and the trimmer folder 10i are joined to the downstream side of the main body 10b, and they are devices that perform post-processing of the printed matter output from the main body 10b.

The main body 10b of the image forming apparatus 10 includes a user interface (abbreviated as UI) device 15 and an antenna unit 18. The image forming apparatus 10 is configured to be able to perform wireless communication with the user terminal 20 via the antenna unit 18.

The user terminal 20 is a terminal for using a function of the image forming apparatus 10. The user terminal 20 includes a display unit 21 that displays a screen.

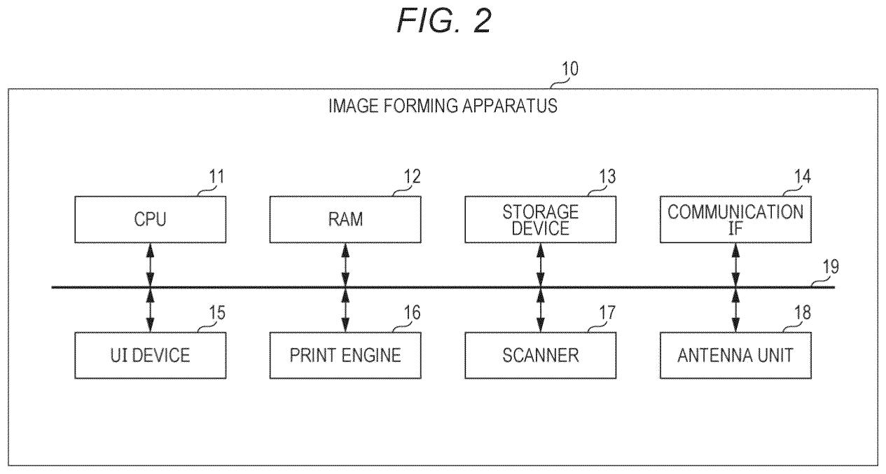

FIG. 2 is a block diagram illustrating a hardware configuration of the image forming apparatus 10. As illustrated in FIG. 2, the image forming apparatus 10 includes a central processing unit (CPU) 11, a random access memory (RAM) 12, a storage device 13 such as a hard disk drive, a communication interface (abbreviated as IF) 14, a UI device 15, a scanner 16, a print engine 17, and the antenna unit 18. These components are connected to each other via a control bus 19.

The CPU 11 is a processor that executes predetermined processing based on a program stored in the RAM 12 or the storage device 13 to control the operation of the image forming apparatus 10. In this exemplary embodiment, the CPU 11 reads and executes the program stored in the RAM 12 or the storage device 13, but the present disclosure is not limited to this configuration. The program may be provided in a form of being recorded on a computer-readable recording medium. For example, the program may be provided in a form of being recorded in an optical disc such as a compact disc (CD)-read only memory (ROM) or a digital versatile disc (DVD)-ROM, or in a form of being recorded in a semiconductor memory such as a universal serial bus (USB) memory or a memory card. The program may be acquired from an external device via a communication line connected to the communication interface 14.

The communication IF 14 performs data transmission and reception with an external device. The UI device 15 includes a touch panel that displays a screen and receives an operation input from a user, and a physical button in which a predetermined function is set. The scanner 16 reads a document loaded in the image forming apparatus 10 as image data. The print engine 17 prints an image on a recording medium, such as a printing paper, through steps such as charging, exposure, development, transfer, and fixing.

The antenna unit 18 includes two antennas 18a and 18b. The antenna unit 18 is connected to the user terminal 20 by a wireless communication method such as Bluetooth (registered trademark) version 5.1 (hereinafter referred to as Bluetooth 5.1).

With Bluetooth 5.1, it is possible to acquire not only the propagation distance of the radio wave received from the user terminal 20 but also the reception angle of the radio wave received from the user terminal 20 by using the two antennas 18a and 18b.

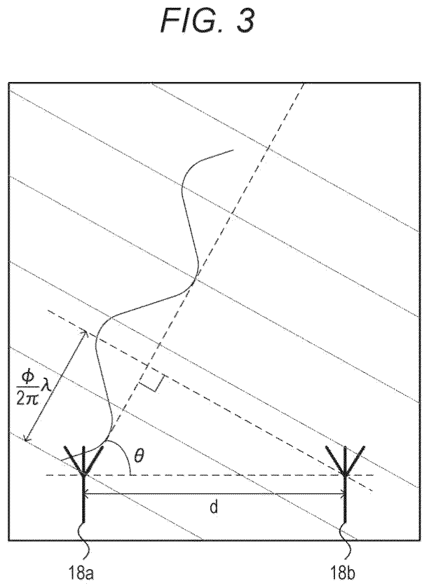

Here, the principle of acquiring the reception angle will be described. As illustrated in FIG. 3, a radio wave incident at a certain angle θ is received by the two antennas 18a and 18b in different phases. In the example of FIG. 3, a phase difference q occurs between the antenna 18a and the antenna 18b because the propagation length is longer in the antenna 18a.

Since the distances d between the two antennas 18a and 18b and the wavelength λ of the radio wave are known, the reception angle θ can be calculated by the following Expression (1).

$$( φ λ / 2 π ) / d = cos θ \qquad ( 1 )$$

The acquisition of the information on the distance and the angle of the user terminal 20 with respect to the image forming apparatus 10 is not limited to the form of using the Bluetooth 5.1 as described above, but any form may be adopted.

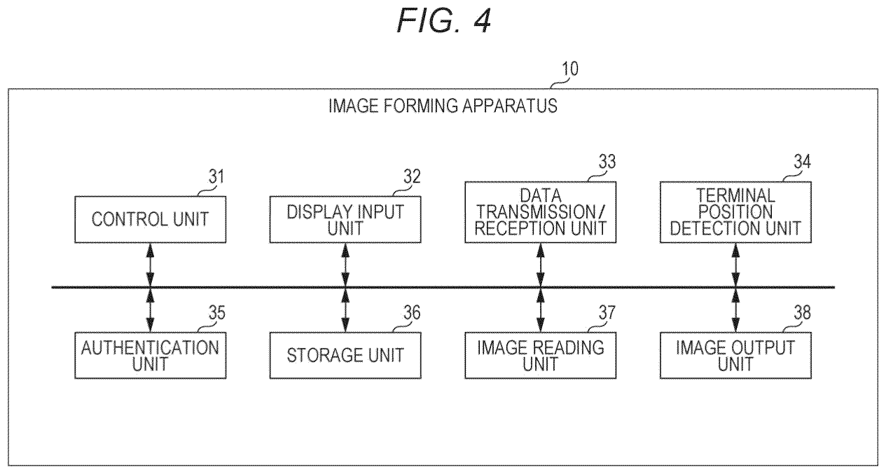

FIG. 4 is a block diagram illustrating a functional configuration of the image forming apparatus 10. As illustrated in FIG. 4, the image forming apparatus 10 according to the present exemplary embodiment includes a control unit 31, a display input unit 32, a data transmission/reception unit 33, a terminal position detection unit 34, an authentication unit 35, a storage unit 36, an image reading unit 37, and an image output unit 38.

The control unit 31 controls the entire operation of the image forming apparatus 10, and it performs control of reading a document image with the image reading unit 37, control of outputting print data from the image output unit 38, and the like based on an instruction input from a user.

The control unit 31 can execute processing called mirroring for displaying the display content of the touch panel constituting the display input unit 32 on the display unit 21 of the user terminal 20.

The display input unit 32 is configured by the UI device 15, displays various kinds of information to the user, and inputs information of various operations performed by the user. The data transmission/reception 33 transmits and receives data to and from an external device such as the user terminal 20. The terminal position detection unit 34 acquires information on the distance and the angle of the user terminal 20 with respect to the image forming apparatus 10 based on a radio wave reception state with the antenna unit 18. The authentication unit 35 executes authentication processing for a user who attempts to use the image forming apparatus 10.

The storage unit 36 stores various kinds of data such as a program for controlling the operation of the image forming apparatus 10. The image reading unit 37 reads a document image from a loaded document based on the control of the control unit 31. The image output unit 38 outputs an image onto a recording medium such as a printing paper based on the control of the control unit 31.

As described above, the image forming apparatus 10 according to the present exemplary embodiment includes a plurality of devices such as the paper feed tray 10a, the main body 10b, the interface decurler 10c, the interposer 10d, the stacker 10e, the vertical trimmer creaser 10f, the paper folding unit 10g, the saddle stitching finisher 10h, and the trimmer folder 10i.

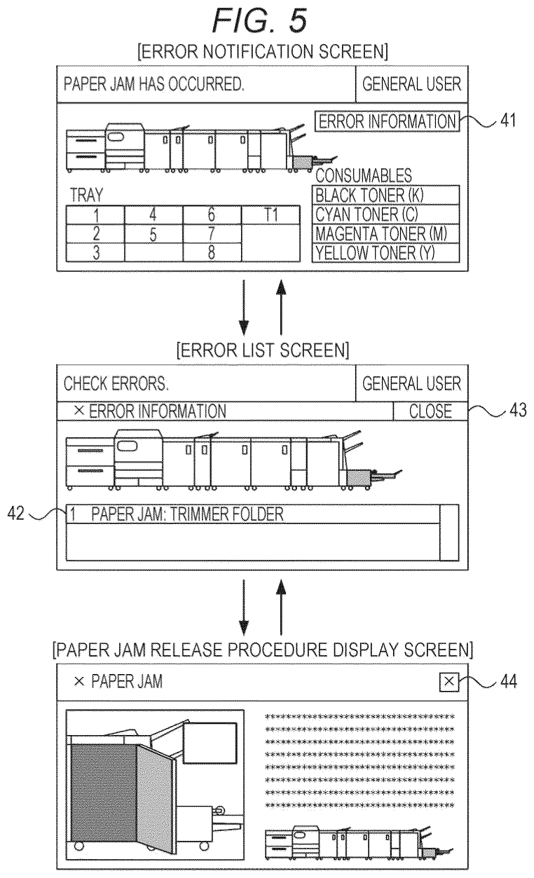

When an error has occurred in any of these devices, error display is performed on the UI device 15 of the main body 10b as illustrated in FIG. 5.

Specifically, when an error has occurred, the control unit 31 displays an error notification screen. On the error notification screen, a device in which an error has occurred in the image forming apparatus 10 is displayed in color, whereby a notification of the device in which the error has occurred is provided. When an “ERROR INFORMATION” button 41 is touched on the error notification screen, the control unit 31 displays an error list screen.

On the error list screen, a device in which an error has occurred in the image forming apparatus 10 is displayed in color, and a list of errors that have occurred in the image forming apparatus 10 is displayed. In the example of FIG. 5, “1 PAPER JAM: TRIMMER FOLDER” is displayed. When the “1 PAPER JAM: TRIMMER FOLDER” button 42 is touched on the error list screen, the control unit 31 displays a paper jam release procedure display screen. When a “CLOSE” button 43 is touched on the error list screen, the control unit 31 displays an error notification screen.

On the paper jam release procedure display screen, a detailed description of the paper jam release procedure in the trimmer folder 10i is displayed. The user can resolve the paper jam in the trimmer folder 10i while viewing the paper jam release procedure display screen. When a “CLOSE” button 44 is touched on the paper jam release procedure display screen, the control unit 31 displays the error list screen.

Here, the main body 10b including the UI device 15 is disposed at the second from the left in the drawing in the image forming apparatus 10, and the trimmer folder 10i is disposed at the ninth from the left (that is, the rightmost end) in the drawing in the image forming apparatus 10.

That is, since six devices are disposed between the main body 10b and the trimmer folder 10i, it is difficult for the user to perform an operation of the trimmer folder 10i while checking the UI device 15 of the main body 10b. Accordingly, the user can perform the operation of the trimmer folder 10i while viewing the user terminal 20 at hand by executing mirroring for displaying the display content of the UI device 15 on the display unit 21 of the user terminal 20.

At this time, the convenience of the user can improve if the error release procedure display screen for the device where the error has occurred is automatically displayed when the user approaches the device.

To meet such a demand, the control unit 31 of the image forming apparatus 10 of the present exemplary embodiment acquires information on the distance and the angle of the user terminal 20 with respect to a specific position, and displays a screen corresponding to a specific area on the display unit 21 of the user terminal 20 when detecting that the user terminal 20 is present within a range set with reference to the specific area among a plurality of areas of the image forming apparatus 10 using the information on the distance and the angle of the user terminal 20.

For example, when an error has occurred in the trimmer folder 10i, a range within 1 m with reference to the trimmer folder 10i is regarded as a work range for handling the error, and when it is detected that the user terminal 20 is present within the work range, the paper jam release procedure display screen for the trimmer folder 10i can be displayed on the display unit 21 of the user terminal 20.

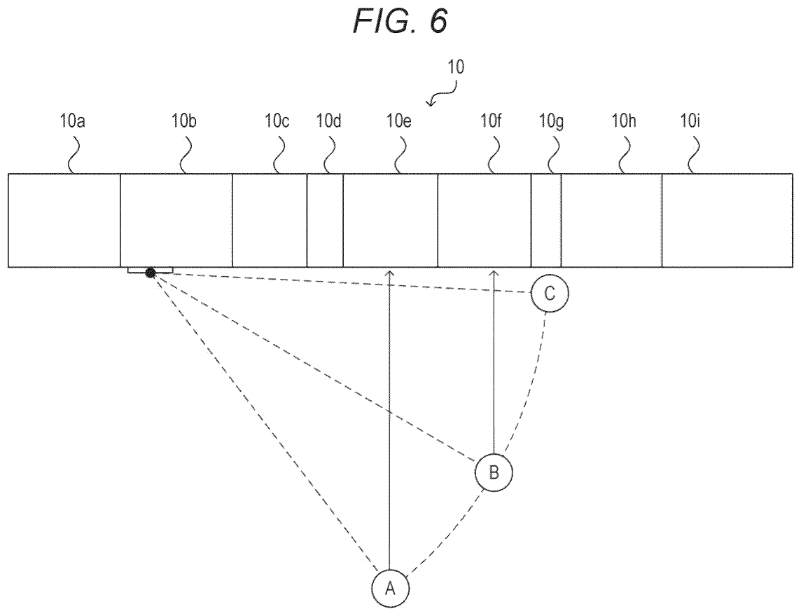

As illustrated in FIG. 6, when only the information on the distance of the user terminal 20 with respect to a specific position is acquired, a situation occurs in which a different device is regarded as the device that the user is directly facing at a certain distance.

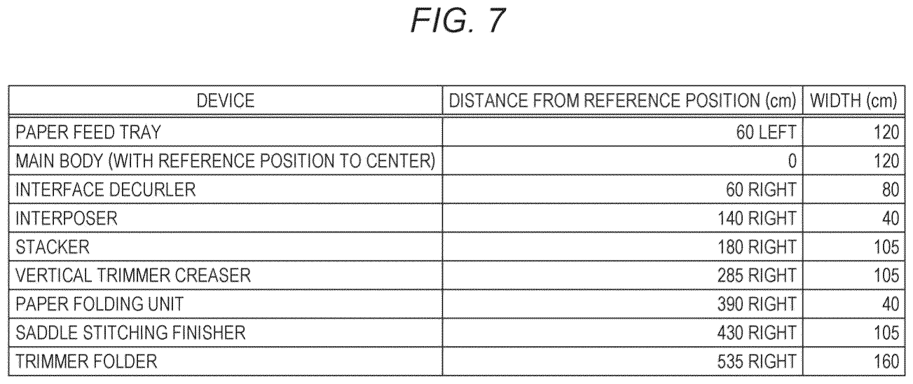

On the other hand, the image forming apparatus 10 according to the present exemplary embodiment acquires information on the distance and the angle of the user terminal 20 with respect to a specific position. As illustrated in FIG. 7, the storage unit 36 of the image forming apparatus 10 stores a device management table in which distance information of each device from the reference position is recorded. The image forming apparatus 10 according to the present exemplary embodiment can accurately identify the device that the user is directly facing by using these pieces of information.

In the image forming apparatus 10 of the present exemplary embodiment, as in the example described above, when an error has occurred in the image forming apparatus 10, the control unit 31 displays, on the display unit 21 of the user terminal 20, a screen for handling the error corresponding to the area in which the error has occurred when it is detected that the user terminal 20 is present within the range set with reference to the area in which the error has occurred using the information on the distance and angle of the user terminal 20.

In this case, when errors have occurred in a plurality of areas, the control unit 31 may display a screen for error handling on the display unit 21 of the user terminal 20 only for one area in which an error having the highest priority has occurred.

When an error has occurred, the control unit 31 performs mirroring processing for displaying the display content of the display input unit 32 on the display unit 21 of the user terminal 20.

In this case, the control unit 31 may stop the mirroring processing when the error has been resolved.

In the image forming apparatus 10 according to the present exemplary embodiment, the control unit 31 may notify the user via the user terminal 20 when it is detected that the user terminal 20 is present at a distance within a set threshold value from a range set with reference to a specific area using the information on the distance and the angle of the user terminal 20.

For example, when an error has occurred in the trimmer folder 10i, a range within 1 m with reference to the trimmer folder 10i may be regarded as a work range for handling the error, the position of 2 m from the work range may be set as the threshold value, and when the user approaches within 2 m from the work range, the user may be notified via the user terminal 20.

As a notification method, any form may be adopted. For example, the display unit 21 of the user terminal 20 may display a message such as “2 m to the target device”, an indicator for indicating that the user has approached the target device may be provided, or a notification sound may be emitted.

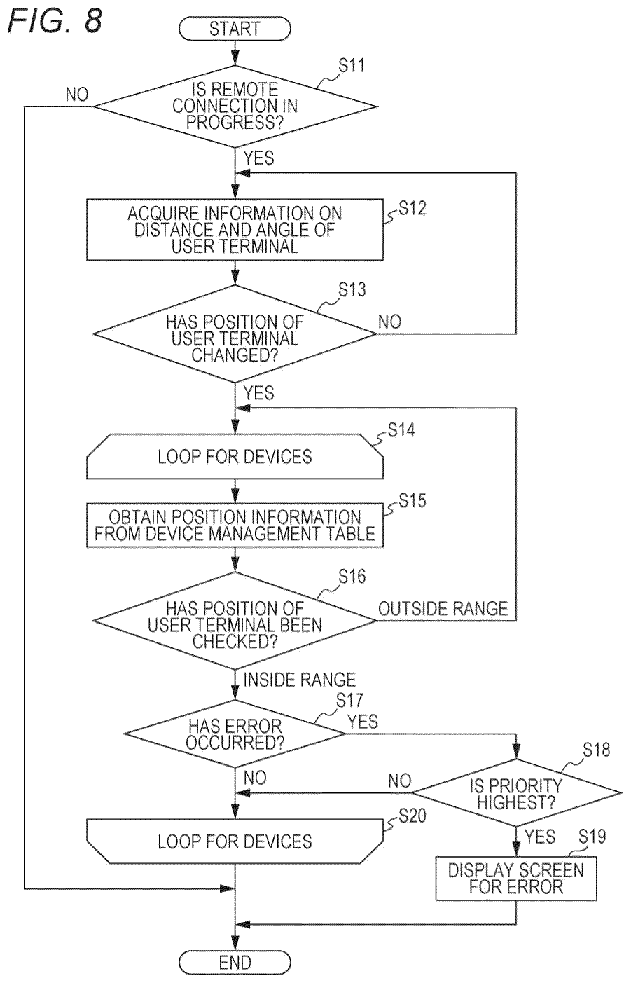

Next, a flow of error display processing at the time of mirroring (that is, at the time of remote connection) in the image forming apparatus 10 of the present exemplary embodiment will be described with reference to the flowchart of FIG. 8.

First, in step S11, the control unit 31 determines whether a remote connection with the user terminal 20 is in progress.

When it is determined in step S11 that a remote connection is not in progress, the control unit 31 ends the processing.

When it is determined in step S11 that a remote connection is in progress, the control unit 31 acquires information on the distance and the angle of the user terminal 20 in step S12.

Next, in step S13, the control unit 31 determines whether the position of the user terminal 20 has changed.

When it is determined in step S13 that the position of the user terminal 20 has not changed, the control unit 31 transitions to step S12.

When it is determined in step S13 that the position of the user terminal 20 has changed, the control unit 31 executes loop processing from step S14 to step S20 for the number of devices included in the image forming apparatus 10.

In the loop processing, first, in step S15, the control unit 31 acquires position information of the device from the device management table.

Next, in step S16, the control unit 31 checks the position of the user terminal 20, and determines whether the position of the user terminal 20 is within the work range of the device.

When it is determined in step S16 that the position of the user terminal 20 is outside the work range of the device, the control unit 31 transitions to step S14.

When it is determined in step S16 that the position of the user terminal 20 is within the work range of the device, the control unit 31 determines whether an error has occurred in the device in step S17.

When it is determined in step S17 that no error has occurred in the device, the control unit 31 transitions to step S20.

When it is determined in step S17 that an error has occurred in the device, the control unit 31 determines in step S18 whether the priority of the error in the device is the highest among the errors currently occurring in the image forming apparatus 10.

When it is determined in step S18 that the priority of the error in the device is not the highest, the control unit 31 transitions to step S20.

When it is determined in step S18 that the priority of the error of the devices is the highest, the control unit 31 displays a screen for resolving the error of the device on the display unit 21 of the user terminal 20 in step S19, and ends the processing.

### Modification Example

Although the image forming apparatus 10 that is an exemplary embodiment of the information processing system of the present disclosure has been described above, the technology of the present disclosure is not limited to the exemplary embodiment described above but can be appropriately modified.

For example, in the exemplary embodiment described above, an example in which the present disclosure is applied to an error display when an error has occurred in the image forming apparatus 10 has been described, but it is possible to adopt a form other than the error display, such as a diagnostic item display at the time of device diagnosis in the image forming apparatus 10.

The present disclosure is not limited to the image forming apparatus 10, but can be applied to various information processing systems such as a production line of a factory or a conveyance system in a warehouse.

In the exemplary embodiment described above, the processor refers to a processor in a broad sense, and it includes general-purpose processors (for example, CPU: central processing unit and the like) and dedicated processors (for example, GPU: graphics processing unit, ASIC: application specific integrated circuit, FPGA: field programmable gate array, programmable logic devices, and the like).

The operation of the processor in the exemplary embodiment described above may be performed not only by one processor but also by a plurality of processors present at physically separated positions in cooperation with each other. The order of the respective operations of the processors is not limited to only the order described in each exemplary embodiment described above but may be appropriately changed.

### [Supplementary Note]

With respect to the exemplary embodiment described above, the following supplementary notes are further disclosed.

(((1)))

An information processing system comprising a processor,
wherein the processor:
acquires information on a distance and an angle of a user terminal with respect to a specific position; and
displays, on a display unit of the user terminal, a screen corresponding to a specific area when detecting that the user terminal is present within a range set with reference to the specific area among a plurality of areas of the information processing system using the information on the distance and the angle of the user terminal.
   (((2)))

The information processing system according to (((1))), wherein
the processor notifies a user via the user terminal when detecting that the user terminal is present at a distance within a set threshold value from a range set with reference to a specific area using the information on the distance and the angle of the user terminal.
   (((3)))

The information processing system according to (((1))) or (((2))), wherein
when an abnormality has occurred and the processor has detected that the user terminal is present within a range set with reference to an area in which the abnormality has occurred by using the information on the distance and the angle of the user terminal, the processor displays, on the display unit of the user terminal, a screen for abnormality handling corresponding to the area in which the abnormality has occurred.
   (((4)))

The information processing system according to (((3))), wherein
when abnormalities have occurred in a plurality of areas, the processor displays, on the display unit of the user terminal, a screen for abnormality handling only for one area in which an abnormality having a highest priority has occurred.
   (((5)))

The information processing system according to (((3))) or (((4))), the information processing system comprising a display input unit that displays a screen and receives an operation input,
wherein when an abnormality has occurred, the processor performs mirroring processing for displaying, on the display unit of the user terminal, a display content of the display input unit.
   (((6)))

The information processing system according to (((5))), wherein the processor stops the mirroring processing when the abnormality has been resolved.

(((7)))

A non-transitory computer-readable storage medium storing a program causing a computer to execute processing comprising:
acquiring information on a distance and an angle of a user terminal with respect to a specific position; and
displaying, on a display unit of the user terminal, a screen corresponding to a specific area when detecting that the user terminal is present within a range set with reference to the specific area among a plurality of areas of the information processing system using the information on the distance and the angle of the user terminal.
   (((8)))

A control method comprising:
acquiring information on a distance and an angle of a user terminal with respect to a specific position; and
displaying, on a display unit of the user terminal, a screen corresponding to a specific area when detecting that the user terminal is present within a range set with reference to the specific area among a plurality of areas of the information processing system using the information on the distance and the angle of the user terminal.

What is claimed is:

1. An information processing system comprising a processor,
wherein the processor:
acquires information on a distance and an angle of a user terminal with respect to a specific position; and
displays, on a display unit of the user terminal, a screen corresponding to a specific area when detecting that the user terminal is present within a range set with reference to the specific area among a plurality of areas of the information processing system using the information on the distance and the angle of the user terminal.

2. The information processing system according to claim 1, wherein
the processor notifies a user via the user terminal when detecting that the user terminal is present at a distance within a set threshold value from a range set with reference to a specific area using the information on the distance and the angle of the user terminal.

3. The information processing system according to claim 1, wherein
when an abnormality has occurred and the processor has detected that the user terminal is present within a range set with reference to an area in which the abnormality has occurred by using the information on the distance and the angle of the user terminal, the processor displays, on the display unit of the user terminal, a screen for abnormality handling corresponding to the area in which the abnormality has occurred.

4. The information processing system according to claim 3, wherein
when abnormalities have occurred in a plurality of areas, the processor displays, on the display unit of the user terminal, a screen for abnormality handling only for one area in which an abnormality having a highest priority has occurred.

5. The information processing system according to claim 3, the information processing system comprising a display input unit that displays a screen and receives an operation input,
wherein when an abnormality has occurred, the processor performs mirroring processing for displaying, on the display unit of the user terminal, a display content of the display input unit.

6. The information processing system according to claim 5, wherein the processor stops the mirroring processing when the abnormality has been resolved.

7. A non-transitory computer-readable storage medium storing a program causing a computer to execute processing comprising:
acquiring information on a distance and an angle of a user terminal with respect to a specific position; and
displaying, on a display unit of the user terminal, a screen corresponding to a specific area when detecting that the user terminal is present within a range set with reference to the specific area among a plurality of areas of the information processing system using the information on the distance and the angle of the user terminal.

8. A control method comprising:
acquiring information on a distance and an angle of a user terminal with respect to a specific position; and
displaying, on a display unit of the user terminal, a screen corresponding to a specific area when detecting that the user terminal is present within a range set with reference to the specific area among a plurality of areas of the information processing system using the information on the distance and the angle of the user terminal.
